(19) United States
(12) Patent Application Publication
(10) Pub. No.: US 2019/0066529 A1
(43) Pub. Date: Feb. 28, 2019

(54) Virtual Reality Learning Management System for Classroom Instructors

(71) Applicant: Steven E. Grubbs, Davenport, IA (US)

(72) Inventor: Steven E. Grubbs, Davenport, IA (US)

(21) Appl. No.: 16/110,552

(22) Filed: Aug. 23, 2018

Related U.S. Application Data
(60) Provisional application No. 62/549,003, filed on Aug. 23, 2017.

(51) Int. Cl. G09B 7/06; G06F 3/01; G06F 3/14

(52) U.S. Cl. CPC G09B 7/06; G06F 3/013; H04L 67/10; G06F 3/14; G06F 3/012

(57) ABSTRACT

A virtual learning system for a student and an instructor includes a virtual reality device worn by the student with an interactive display, in which the virtual reality device is configured to display user data, assessment data, and results data related to a learning activity for the student. A cloud server stores the user data, the assessment data, and the results data of the learning activity. A first computing device operably connected to the virtual reality device and to the cloud server is configured to send and receive the user data and the assessment data between the virtual reality device and the cloud server, and to control the virtual reality device based on the data received from the cloud server. A second computing device is operably connected to the cloud server and operable by an instructor separate from the student to create or access at least one of the user data, the assessment data, and the results data of the learning activity.

### CROSS-REFERENCE TO RELATED APPLICATIONS

This application claims priority to U.S. provisional patent application No. 62/549,003, filed Aug. 23, 2017, the disclosure of which is incorporated herein by reference in its entirety.

### FIELD

This document relates to the field of virtual reality and particularly to virtual reality learning environments.

### BACKGROUND

Immersive visual learning and engagement have been shown to improve knowledge retention and engagement by students which in turn leads to higher test scores and increased interest by students. Traditional immersive education designed to increase student engagement includes activities both in the classroom and field trips to off-campus locations. Field trips are typically very appealing to students, but are often cost prohibitive to many school districts. Moreover, the traditional field trip can include many distractions such that the instructor may not have a way to gauge the knowledge retention or engagement by the students. Alternative activities in the classroom, such as games and presentations, may have the benefit of less distractions than traditional field trips, but the classroom environment often times is not as stimulating as off-campus trips.

Virtual reality learning provides a new way to engage students with content and immersive visual engagement not generally available in the traditional classroom setting. Virtual reality can provide the benefits of immersing the students in an alternative, foreign environment that provides a change from the monotony of the classroom environment, while also keeping the students under constant supervision with limited distractions. Students can participate in thought-provoking and exciting virtual reality activities, thus improving knowledge retention and overall engagement in the learning experience.

Although virtual reality systems are currently utilized in classroom learning experiences, such systems can present problems for schools and instructors. Virtual reality systems are costly and the supporting hardware can be quite cumbersome for the size of an average classroom. Furthermore, educational materials such as assessments, questions, and student answers may not be readily accessible to instructors and students if multiple virtual reality systems are being utilized simultaneously in the classroom. Therefore, it would be useful to have a relatively inexpensive, practicable immersive virtual reality technology that students can interact with that can also improve their knowledge retention while providing instantaneous feedback and management tools to the instructor.

### SUMMARY

In one aspect of the present disclosure, a virtual learning system for at least one student and at least one instructor is provided that comprises a virtual reality device to be worn by the student and including at least one interactive display configured to be viewable by the student, in which the virtual reality device is configured to display user data, assessment data, and results data related to a learning activity for the student on the at least one interactive display. The learning system further includes a cloud server including at least one storage device configured to store the user data, the assessment data, and the results data of the learning activity, and at least one processor configured to perform data processing of the data for the learning activity.

A first computing device is operably connected to the virtual reality device and to the cloud server, and configured to send and receive the user data and the assessment data between the virtual reality device and the cloud server, and to control the virtual reality device based on the user data, the assessment data, and the results data received from the cloud server. A second computing device is operably connected to the cloud server and operable by an instructor separate from the student to create or access at least one of the user data, the assessment data, and the results data of the learning activity. The cloud server is configured to provide the student and the instructor continuous access to the results data.

In another aspect of the disclosure, a method of virtual learning for a student in performing a learning activity comprises entering a virtual reality environment via a virtual reality device including at least one interactive display and operably connected to a first computing device, in which the virtual reality device is configured to display user data, assessment data, and results data related to the learning activity for the student on the at least one interactive display. The method further includes accessing at least one assessment via a communicative connection between the first computing device and a cloud server including at least one storage device configured to store the user data, the assessment data, and the results data, in which the first computing device is configured to send and receive the user data, the assessment data, and the results data between the virtual reality device and the cloud server, and to control the virtual reality device based on the user data, the assessment data, and the results data received from the cloud server.

In a next step, the at least one assessment of the learning activity is performed via the at least one interactive display of the virtual reality device, with the cloud server configured to store the results data in real-time as the at least one assessment is performed and send the results data to the first computing device. Then the results data of the at least one assessment are reviewed via the at least one interactive display of the virtual reality device or via a second computing device operably connected to the cloud server operable by an instructor separate from the student to create or access at least one of the user data, the assessment data, and the results data at any time while the method of virtual learning is carried out.

The above described features and advantages, as well as others, will become more readily apparent to those of ordinary skill in the art by reference to the following detailed description and accompanying drawings. While it would be desirable to provide a headwear device that provides one or more of these or other advantageous features, the teachings disclosed herein extend to those embodiments which fall within the scope of any appended claims, regardless of whether they accomplish one or more of the above-mentioned advantages.

### BRIEF DESCRIPTION OF THE DRAWINGS

FIG. 1 shows a schematic representation of an embodiment of a virtual learning system;

FIG. 2 shows a question display of the virtual learning device of FIG. 1; and

FIG. 3 shows a method of performing an assessment using a virtual learning system.

### DETAILED DESCRIPTION

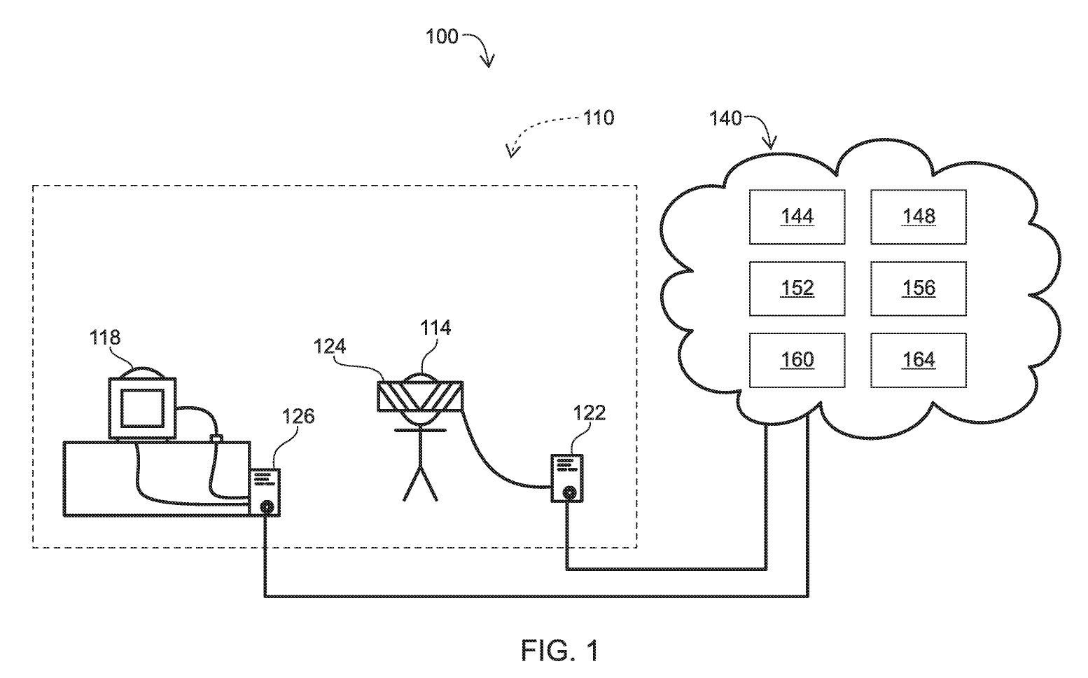

With reference to FIG. 1, a virtual learning system 100 is shown. The virtual learning system 100 is configured for use in a local learning environment 110. The virtual learning system 100 includes a local virtual reality computer 122, an instructor computer 126, and a cloud database 140.

The local learning environment 110 is where the user-end learning process takes place. In this particular embodiment, the local learning environment 110 is a school classroom in which at least one student 114 and at least one instructor 118 are present in order to carry out an assessment using the virtual learning system 100. In other embodiments, the local learning environment 110 may be a workplace, a training center, or other such environments where learning and education are required.

Furthermore, although in the present embodiment both a student 114 and an instructor 118 are working together at the location of the local learning environment 110, the presence of the student 114 and the instructor 118 in the same location is not required by virtue of the cloud-based features of the virtual learning system 100 which will be described in greater detail below. For example, only the student 114 may be present at the local learning environment 110 and the instructor 118 may be at an off-site location remotely controlling teaching parameters of the virtual learning system 100 via a virtual private network or another method. Similarly, only the instructor 118 may be present at the local learning environment 110 and the student 114 may be located off-site accessing assessment materials of the virtual learning system 100 via a virtual private network or another method.

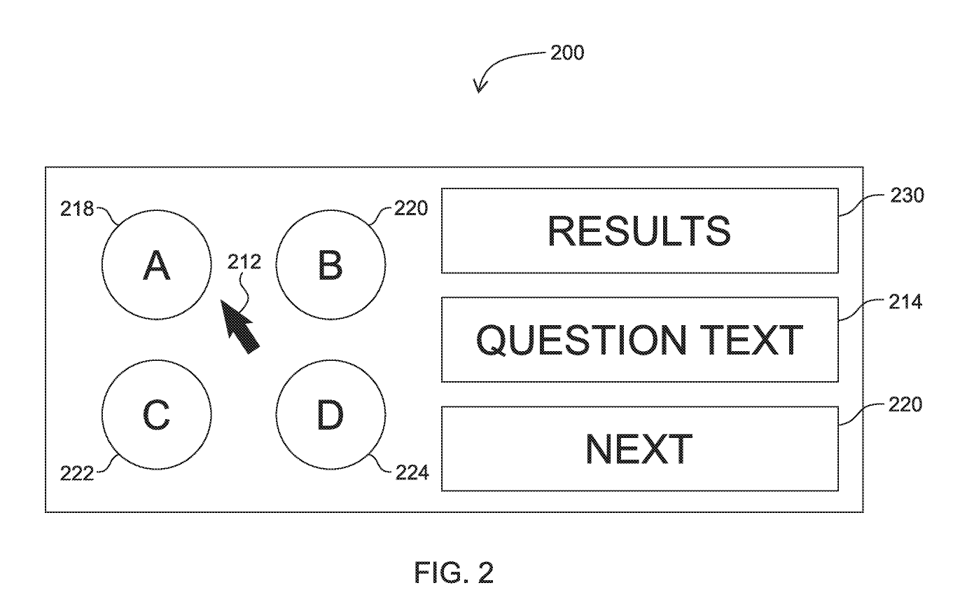

As can be seen in FIG. 1, the virtual learning system 100 includes the local virtual reality computer 122 configured to control a virtual reality headset 124, and the local instructor computer 126. In a local learning environment 110 in which both the student 114 and the instructor 118 are present in the same location, the virtual reality computer 122 and the instructor computer 126 are located in the same location as well. In embodiments in which the student 114 and the instructor 118 are not present in the same location, the virtual reality computer 122 and the instructor computer 126 are located with the student 114 and the instructor 118, respectively. The virtual reality computer 122 and the instructor computer 126 may be a standard desktop personal computer, a tablet, smartphone, or any other computing machine capable of controlling the virtual reality system 100. The virtual reality computer 122 typically includes at least one graphical processing unit or integrated graphics processor capable of displaying graphics on the display 200 of the virtual reality headset 124 (FIG. 2).

The virtual reality headset 124 used with the virtual learning system 100 may be chosen from a variety of virtual reality headsets well known in the art. For example, the headset 124 may be a PC-connected headset that connects to a personal desktop computer, such as the Oculus-Rift, HTC Vive, or FOVE. The headset 124 may also include smartphone virtual reality head-mounted displays, such as the Samsung GearVR or the Zeiss VR One. In embodiments in which a smartphone virtual reality headset is utilizes, the associated smartphone would require an internet connection. In other embodiments, the local virtual reality computer 122 may be connected to a non-head-mounted virtual reality kit.

The virtual reality headset 124 is configured to receive inputs from the student 114. In the present embodiment, the virtual reality headset 124 is configured to interpret the student's 114 head and eye movements to control a cursor 212 on the display 200 of the headset 124, as shown in FIG. 2. As a result, the student 114 is able to control and interact with the graphical display of the headset 124. In other embodiments, the student 114 may control the display 200 via hand-held joystick controllers, gaming controllers, a mouse and keyboard, or other known input methods.

As part of the learning experience, the virtual learning system 100 includes learning modules containing teaching materials that will be reviewed and tested in an assessment. The student 114 may review the learning modules via the virtual reality headset 124 before accessing the assessment described below. In the disclosed embodiment, the local virtual reality computer 122 stores the learning modules and is configured to display the learning modules on the virtual reality headset 124 such that the student 114 may interact with the learning modules. In other embodiments, the learning modules may be stored on the cloud database 140 and accessed by either the instructor 118 or the student 114 via an internet connection between the cloud database 140 and the local computers 122, 126.

The virtual learning system 100 further includes an assessment which tests the student's 114 knowledge regarding the materials discussed in the learning modules. The cloud database 140 stores and processes the information related to the assessment. In particular, in the present embodiment, the cloud database 140 includes an identification database 144, a question database 148, an answer database 152, a data analyzer 156, a results database 160, and a results aggregator 164. The cloud database 140 may be stored on a cloud server, which is either a physical or virtual infrastructure of hardware and/or software capable of delivering various computing services over the internet. In this case, such computing services may include the storage of information in the various databases or the code to run the virtual learning system 100. The cloud database 140 may also include at least one processor configured to process data and other information in, for example, the various databases.

The cloud database 140 may be accessed at any time by the instructor 118 to enter student names, assign assessments to students, assign unique pin codes to students that connects their name to their results, and review the results of all assessments of all students. This constant access also allows for such modifications as editing content, placing restrictions, and analyzing results.

The identification database 144 is configured to store student names and/or identifiers, unique pin code identifiers, and instructor names and/or identifiers. In one embodiment, the virtual learning system 100 includes a student log-in feature. The student 114 may be required to log in to the local virtual reality computer 122, to the cloud database 140 to access the assessment, or both. The student 114 is assigned a unique pin code and uses the code in order to log in to the virtual learning system 100. In one embodiment, the unique pin code is a 4-digit identifier. The student 114 may log in to the assessment via eye or head movements using the virtual reality headset 124. The instructor 118 may also be given privileges to override the log-in feature in the case of forgotten unique pin codes. Once the assessment is accessed by the student 114 after logging in, the virtual reality headset 124 displays a menu to the student 114 on the display 200, allowing the student 114 or instructor 118 to select an assessment to perform.

The assessment pulls questions from the question database 148 for the student 114 to perform. The question database 148 is configured to store questions for the assessment and to display the questions on the display 200 of the virtual reality headset 124, allowing the student 114 to interact with and answer the questions. The assessment may be coded using a range of programming methods and languages, including but not limited to Objective-C programming language or the Unity Game Engine. Furthermore, the assessment may include a variety of designs based on the intended learning audience. For example, the assessment may be designed with colorful shapes and animations for younger students, while the assessment may also be designed with minimal aesthetics for students with greater attention spans. In the present embodiment, the code for the display of the assessment on the virtual reality headset 124 is stored and run locally on the local virtual reality machine 122, but in other embodiments, the code may be stored and run remotely from the cloud 140.

The assessment may contain a variety of question types and arrangements of information. In one example, shown in FIG. 2, a question text 214 is displayed along with four answer choices 218, 220, 222, 224. Once the assessment question is presented the student 114 rests the virtual reality cursor 212 on an answer for two or three seconds. The cursor 212 can be moved via head or eye movements or through other methods such as the hand held controllers discussed above. The chosen answer is designated by a color change, highlight, or other indicators, and then the student can move the cursor 212 through the means noted above to move the cursor 212 to the “NEXT” graphic 220 that allows the student 114 to advance to the next question. Furthermore, a “RESULTS” graphic 230 may be displayed at all times that allows the student 114 to access real-time results of the assessment.

The assessment questions may be presented with as much text and as many answer choices as are necessary for the student's 114 education level, the material being tested, and the instructor's 118 requirements. Moreover, in some embodiments, the assessment may include additional interactive features such as images and videos. The virtual reality headset 124 may also be configured to allow the student 114 to speak answers into the device. The assessment questions may also be accessed by the instructor 118 via the instructor computer 126 which is connected to the cloud database 140 and in some embodiments, to the virtual reality computer 122. Thus, the instructor 118 may edit and adjust the content of the assessment at any time.

Once the student 114 has selected an answer to a question, the answer is stored in the answer database 152 of the cloud database 140. In one embodiment, the answer database 152 is a Structured Query Language (SQL) database that is located on the cloud database 140 platform. The answer database 152 is configured to organize the answer data, such as by question number, by student name, or other criteria via the processor of the cloud database 140.

In one embodiment, once the answer database 152 receives an answer from the question database 148, the data analyzer 156 scores the answer as correct or incorrect via the processor of the cloud database 140. In other embodiments, the data analyzer 156 may be configured to analyze further content of the question, such as whether the answer was partially correct or whether or not the question was skipped without the student 114 selecting an answer. The data analyzer 156 is configured to send the analysis of the question to the results database 156 and the results aggregator 164, and in some embodiments, to the local virtual reality computer 122 and the local instructor computer 126 via an internet connection.

As the student 114 continues to finish questions and submit answers, the data analyzer 156 continuously analyzes the answers as they are received and sends the analysis to the results database 160 and the results aggregator 164. Once the student has completed all questions, the total results of the assessment are organized and finalized in the results database 160 and the results aggregator 164. The final results can then be accessed and viewed through graphics generated on the display of the virtual reality headset 124 by the student 114 or instructor 118 via an internet connection to the cloud database 140, or the final results can be sent to the local virtual reality machine 122 and the local instructor machine 126. At this point, the student 114 and instructor 118 have the option of drilling down into each of the questions contained in the assessment to see the answer the student chose compared to the correct answer.

After the assessment is complete, the student's 114 results are stored in an individual file in the results database 160 and/or the results aggregator 164 and are accessible to the instructor 118. This gives the instructor the ability to see which assignments have been completed by the student as well as individual student results. For teaching purposes and for curriculum development purposes, the aggregate results of all questions among all students 114 are calculated and provided in the results aggregator 164 via the processor of the cloud database 140. No individual information is collected within these results, as the data is aggregated with no personal identifiers. This aggregated and de-personalized feedback data can also be provided to the curriculum and content producers to evaluate and improve the educational materials.

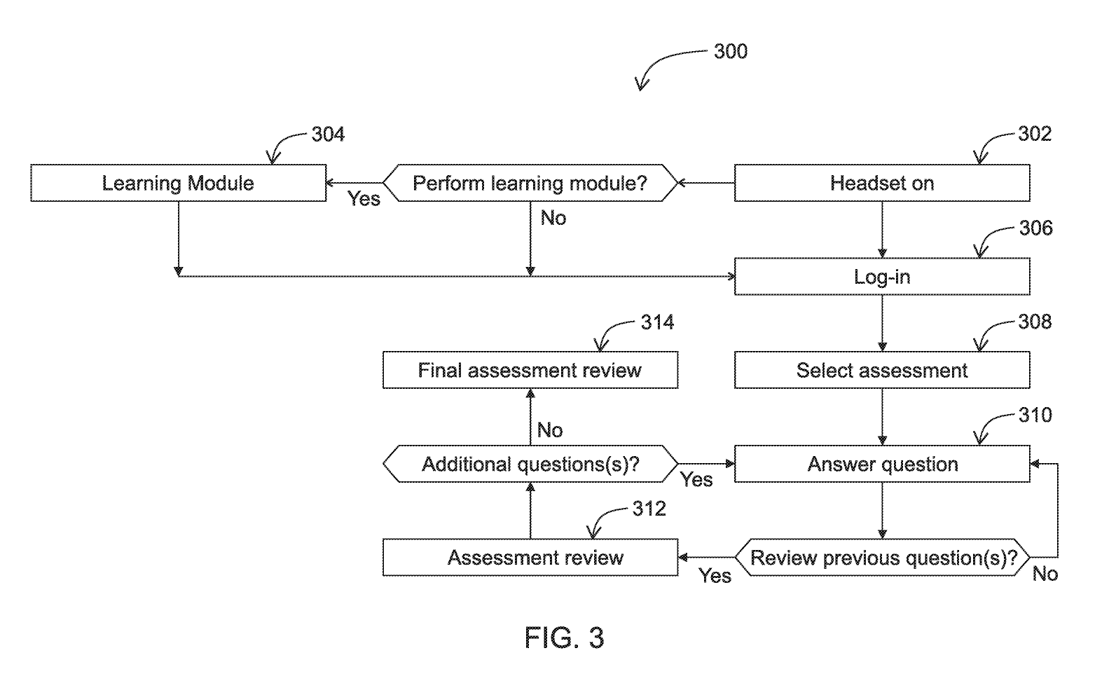

A method of performing an assessment using the virtual learning system 100 is described with reference to FIG. 3. The method 300 consists of a first step 302 in which the student 114 puts on the virtual reality headset 124 and either student 114 or instructor 118 boots up the local virtual reality computer 122. The student then has the option of performing a second step 304 of reviewing a learning module or modules. Once the student finishes reviewing the learning module or modules, or in the event the student initially opted to not review any learning modules, a third step 306 of logging in to the assessment is performed by the student. In one embodiment, the student uses head and/or eye movements to enter the unique pin code and log in to the assessment. A fourth step 308 includes selecting a particular assessment to perform, which may be selected by either the student 114 or the instructor 118.

A fifth step 310 includes answering at least one question of the assessment. After answering the question, the student 114 and/or instructor 118 is given the option reviewing that question and answer or all questions and answers up until that point. If the student 114 and/or instructor 118 choose not to review the questions and answers, the student 114 proceeds to answer the next question of the assessment 310. If the student 114 and/or instructor 118 does choose to review the questions and answers, a sixth step 312 of assessment review is performed. During this step, the student 114 and/or instructor 118 may review each of the questions contained in the assessment to see the answer the student chose compared to the correct answer. After the assessment review step 312, if there are additional questions in the assessment to complete, the student 114 may proceed to the additional questions. If there are no remaining questions, a seventh step 314 of final assessment review is performed in which the student 114 and/or the instructor 118 may perform a final review of the entire assessment.

The above-described virtual learning system 100 is disclosed in the context of a classroom use. However, it is envisioned that the virtual learning system 100 can have applications beyond the classroom such as for workplace education, training and certifications as well as, for example, and first-aid and CPR certifications. The virtual learning system 100 disclosed herein can be adapted for many uses inside educational institutions, workplaces which require training or certifications, and any other institution where education and training are necessary or beneficial.

The foregoing detailed description of one or more exemplary embodiments of the virtual learning system has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed exemplary embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the exemplary embodiments contained herein.

What is claimed is:

1. A virtual learning system for at least one student and at least one instructor for performing a learning activity by the student, comprising:
a virtual reality device to be worn by a student and including at least one interactive display configured to be viewable by the student, the virtual reality device configured to display user data, assessment data, and results data related to a learning activity for the student on the at least one interactive display;
a cloud server including:
at least one storage device configured to store the user data, the assessment data, and the results data of the learning activity; and
at least one processor configured to perform data processing of at least one of the user data, the assessment data, and the results data of the learning activity;
a first computing device operably connected to the virtual reality device and to the cloud server, the computing device configured to send and receive the user data and the assessment data between the virtual reality device and the cloud server, and to control the virtual reality device based on the user data, the assessment data, and the results data received from the cloud server; and
a second computing device operably connected to the cloud server operable by an instructor separate from the student to create or access at least one of the user data, the assessment data, and the results data,
wherein the cloud server is configured to provide the student and the instructor continuous access to the results data.

2. The virtual learning system of claim 1, wherein the user data includes at least one of student names, student identification numbers, unique pin code identifiers, instructor names, and instructor identification numbers.

3. The virtual learning system of claim 1, wherein the assessment data includes at least one question to be answered by the student and at least one answer given by the student.

4. The virtual learning system of claim 3, wherein the at least one question is stored in a question database of the cloud server, and the at least one answer is stored in an answer database of the cloud server.

5. The virtual learning system of claim 3, wherein the at least one processor is configured to:
analyze the at least one answer as one of correct, incorrect, or partially correct; and
generate the results data based on the analysis of the at least one answer and store the results data in a results database.

6. The virtual learning system of claim 5, wherein:
the at least one processor is configured to compile the results data and send the compilation of results data to the first computing device.

7. The virtual learning system of claim 5, wherein:
the cloud server further includes a results aggregator; and
when the virtual learning system is used by multiple students, the at least one processor is configured to compile the results data of the multiple students and store the compilation of results in the results aggregator.

8. The virtual learning system of claim 7, wherein the cloud server is configured to provide the instructor continuous access to the results aggregator.

9. The virtual learning system of claim 1, wherein:
the at least one storage device is configured to store executable code; and
the executable code is executed by the first computing device to control the virtual reality device.

10. The virtual learning system of claim 1, wherein the at least one interactive display is configured to be controlled by the student via eye movement.

11. The virtual learning system of claim 1, wherein the at least one interactive display is configured to be controlled by the student via head movement.

12. A method of virtual learning for a student, comprising:
entering a virtual reality environment via a virtual reality device including at least one interactive display and operably connected to a first computing device, the virtual reality device configured to display user data, assessment data, and results data related to the learning activity for the student on the at least one interactive display;
accessing at least one assessment via a communicative connection between the first computing device and a cloud server including at least one storage device configured to store the user data, the assessment data, and the results data, the first computing device configured to send and receive the user data, the assessment data, and the results data between the virtual reality device and the cloud server, and to control the virtual reality device based on the user data, the assessment data, and the results data received from the cloud server;
performing the at least one assessment via the at least one interactive display of the virtual reality device, the cloud server configured to store the results data in real-time as the at least one assessment is performed and send the results data to the first computing device; and
reviewing the results data of the at least one assessment via the at least one interactive display of the virtual reality device or via a second computing device operably connected to the cloud server operable by an instructor separate from the student to create or access at least one of the user data, the assessment data, and the results data at any time while the method of virtual learning is carried out.
